(19) United States
(12) Patent Application Publication
(10) Pub. No.: US 2013/0196882 A1
(43) Pub. Date: Aug. 1, 2013

(54) FLOW ADDITIVE FOR LIGHT OR HEAVY CRUDE OILS, USE OF THE ADDITIVE AND PROCESS TO IMPROVE THE EXTRACTION, PUMPING AND/OR TRANSPORT OF LIGHT OR HEAVY CRUDE OILS

(71) Applicant: Lino Firmano Junior, Sao Paulo (BR)

(72) Inventor: Lino Firmano Junior, Sao Paulo (BR)

(21) Appl. No.: 13/822,219

(22) PCT Filed: Jun. 29, 2011
(86) PCT No.: PCT/BR11/00194

§ 371 Date: Mar. 11, 2013

(30) Foreign Application Priority Data
Jun. 30, 2010 (BR) PI 1002001-2

(51) Int. Cl. C09K 8/524

(52) U.S. Cl. CPC C09K 8/524
USPC 507/90

(57) ABSTRACT

The present invention refers to a flow additive useful to improve the extraction and displacement of light or heavy crude oils, which comprises an aqueous emulsion containing hollow or solid synthetic microspheres, a component able to alter the superficial tension, high molecular weight polyelectrolytes, a glycol-type antifreeze and fluidity improvement agent and a thickening agent. The additive according to the present invention improves the flow of crude oil pumped from the wells to storage tanks and also cleans and prevents against incrustations of paraffin and heavy hydrocarbons derived from the perforation of the petroleum wells drilling, even though in low temperatures (below of 0 Celsius degrees).

### FIELD OF THE INVENTION

The present invention refers to a flow additive useful to improve the extraction and displacement of light or heavy crude oils, which comprises an aqueous emulsion containing hollow or solid synthetic microspheres, a component able to alter the superficial tension, high molecular weight polyelectrolytes, a glycol-type antifreeze and fluidity improvement agent and a thickening agent. Said additive provides improvement in the extraction flow, pumping and transport of the oils and also prevents against incrustations in the lines, mainly in low temperatures.

### BACKGROUND OF THE NVENTION

The extraction, pumping and transport of light of heavy crude oils cause serious problems for the petroleum drilling and refining companies, due to high viscosity of the crude oil and the paraffin and other hydrocarbons deposition in the interior of the lines designed to oil transport, what leads to the formation of paraffin and other heavy hydrocarbons incrustations causing clogging in the equipments and lines.

Several methods had been suggested to improve the extraction, pumping and transport of crude oils such as: aqueous emulsion formation or dispersions, addition of lighter fractions of hydrocarbons, installation of heaters throughout the tubing's, thermal fractionnement, among others.

U.S. Pat. No. 5,934,303 describes an aqueous solution with hydrosoluble sulphonated dispersant agents selected from alkaline metals or ammonia salts, by the reduction of the crude oil viscosity, facilitating its pumping for the tubing.

U.S. Pat. No. 4,246,920, U.S. Pat. No. 4,285,356, U.S. Pat. No. 4,265,64 and U.S. Pat. No. 4,249,554 describe emulsions containing 50% of oil.

U.S. Pat. No. 4,770,199 describes emulsifying agents in a mixture of non ionic alkoxylated with carboxylated surfactants.

U.S. Pat. No. 6,818,599 describes an unstable emulsion of water and oil used as a fluid to improve the flow during the extraction of the crude oil.

The patent application BR0502142 describes a process for pumping and transport light and heavy oils using an aqueous emulsion containing microspheres.

Disadvantages of the processes currently used are: the addition of hydrocarbon light fractions involves the use considerable amounts of organic solvents, which are relatively expensive and, moreover, it is necessary the presence of an available source of said hydrocarbons.

Heaters can be used to diminish the viscosity of the oil, for it is inversely proportional to the temperature. For the functioning of these equipments, the oil removed from the well can be used as combustible; however, this procedure can result in a loss of 15-20% of the oil.

The thermal fractionnement is an expensive process and involves the gas formation as by-product.

The state of the art does not present a solution that can simultaneous or alternatively improve the extraction, the pumping and the transport of light or heavy oils and also preventing the formation of incrustations in the lines, even though in low temperatures (below of 0 Celsius degrees).

### BRIEF DESCRIPTION OF THE INVENTION

The present invention refers to flow additive to improve the extraction, pumping and transport of light and heavy crude oils characterized by comprising an aqueous emulsion containing hollow or solid microspheres based on ceramic, metallic, polymeric, borosilicate-containing glass, alkaline silicate or oxide of zirconium, but not limited to these, with a diameter equal or inferior than 1,000 microns with a high lubrication attribute (for instance commercialized by 3M™, PQ Corporation™, Nobel Industries™, under the trademark Scotchlite Glass Bubbles™, Zeospheres Ceramic Microspheres™, Z-Light Spheres™, Q-Cel™, Expancel™, among others).

The aqueous emulsion according to the present invention also contains other composites, which contribute advantageously for the processes of extraction, pumping and transport of light or heavy crude oils, even though in low temperatures.

### DETAILED DESCRIPTION OF THE INVENTION

The microspheres of the aqueous emulsion according to the present invention are perfectly spherical particles, with diameter inferior to 1,000 microns, hollow or solid, with variable chemical composition, for example, based on glass such as borosilicate or alkaline silicate, based on ceramics such as alumina and silica-alumina, based on polymers as PVDC, metallic, and based on zirconium oxides among others.

Said microspheres act in the formation of a film between the surface of the tubing and the crude oil, presenting an improved flow of the oil. In addition to the flow effect, the microspheres act mechanically, avoiding the formation of paraffin and heavy hydrocarbons incrustations, which are present in the oils that removed from the wells.

The microspheres are widely used in applications where the density reduction is desired, also in order to increase the charge without significant alteration in viscosity and in order to improve applicability, among others characteristics.

The advantage in the use of microspheres is an attribute of its physical form, with small superficial area thus allowing to a bigger charge in comparison to other types of available inert filling and the ball bearing effect, that almost forms a sphere film in the interface of the oil with the wall of the tubing, facilitating the flow and increasing the pumping.

The emulsion of the present invention contains a solid contend of 0.1%-40% corresponding to the microspheres, depending on the application.

Moreover, the aqueous emulsion comprises a superficial tension alteration component that can be selected from fluorated composites that confer low superficial tension. This low superficial tension allows the emulsion removes the impregnated incrustations and residues in the internal surface of the pumping tubing of crude oil.

The fluorated compounds of the present invention are selected from the group that consists of perfluoroctanes, perfluorobutanes, perfluoroalkyl such as sulfonates, fluoroaliphatic, carboxilates, alcoxilates, esters, fluorochemistry acrylates, for instance ionic, cationic or non ionic.

This property can also be reached using a superficial tension alterator component that can be selected from an anionic and/or non ionic tensoactive, particularly sulphonate hydrocarbons, ethoxylates, of silicone origin or fluorates. The tensoactives can be selected from sodium dioctyl sulfosuccinate, ethoxylate secondary alcohol, ethoxylate nonil phenol with 4 and 5 ethoxylation moles.

The emulsion according to the present invention also contains a resin to the polytetrafluoroethylene base (PTFE), which contains low attrition coefficient and superficial energy. Thus, there is a considerable reduction in the consuming of the mobile parts of the pump dosing part.

The PTFE resin can be used in form of aqueous dispersion, micron powder, fine or granular powder in pure form or containing fillings base on molybdenum disulfide, graphite, among others.

PTFE resin examples are the one commercialized by 3M™, Dupont™, Soludy Solexis™, ICI™ among others under the trademarks Dyneon PTFE™, Teflon™, Zonyl™, Polyflon™, among others.

Moreover, the emulsion of the present invention comprises polyeletrolytes, which can be selected from polymers or copolymers containing ionic constituents capable to conduct electric chain by means of the migration of its ions. These polyelectrolytes contain at least a monomer ion component, such as an acid group, and electrolytic in aqueous medium.

Examples of appropriate monomer materials, which can provide electrolytic and ionized portions, but not being limited to these, are: acrylic acid, 2-acrylamide-2-methyl-1-propanesulphonic acid, sulfopropyl acrylate salts, maleic anhydride, itaconic anhydride, B-carboxy ethylacrilate, vinylaziactone-glycol acid adduct, estyrene sodium sulphonate or combinations thereof.

In particular embodiment, the polyelectrolytes according to the present invention are those of high molecular weight and anionic charge. For application easiness, the polyelectrolytes according to the present invention are included in emulsion of about 0.2 to about 1.5%, particularly about 1%.

For low temperatures applications, where the light oil can be heavy, compromising more the extraction, pumping and transport of crude oils, the emulsion according to the present invention also contains an antifreeze and flow enhancer ingredient, particularly a glycol.

The emulsion of the present invention also contains from about 0.2 to about 3% of a thickening agent chosen from at least one cellulose derivative, particularly methyl cellulose.

The main characteristics of this emulsion are high stability to decantation of solids and staging, low superficial tension, high flow and formation of residual film in the interior of the tubing, even though in low temperatures. Its characteristic of flow increase is superior to the products currently used for the same application.

Also, when injected in the well it provides considerable increase in the extraction outflow, which varies in view of the injected emulsion, able to exceed up to 800% of improvement.

The additive according to the present invention modifies substantially only the superficial layer of the chain, facilitating the draining of the chain. Said superficial layer it can range from about 1 to about 3 mm. This is highly advantageous, for if the additive penetrates in all the extension of the chain, it would compromise the draining and, consequently, increase in the cost of the pumping process.

In a second aspect, the present invention contemplates the use of the flow additive detailed herein as assistant to the extraction, pumping and/or transport of light or heavy crude oils, providing an increase of performance of more than 800%.

In one third aspect, the present invention deals with a process to improve the extraction, pumping and/or transport of light or heavy crude oils comprising to add said flow additive detailed herein to the oil chain in the concentration of 100 to 10,000 ppm.

Examples of particular embodiments of the invention are described below, without creating any limitations to the scope of the invention as defined in the set of claims.

### EXAMPLES

### Example 1

In a mixture tank equipped with mixer in helix form, it was added an amount corresponding to 30-50% of the total volume maintain continuous speed agitation.

30-60% glycol were added and, after that, 0.2-3% high molecular weight polyeletrolyte (commercialized, for example, by Aratrop Industrial™, under the trademark Art Floc 1530™ or Unifloc 5050 or Unifloc 1040 by Unisol Brasil).

Then it was added, 1 to 4% of a humectants system in the 0.2% concentration, containing an anionic fluoro component and a non ionic one (commercialized, for example, for the companies: Dupont™, 3M™, Manson Chemical Company™, Ciba Specialty Chemical™, under the marks: Zonyl™, Novec™, Masurf™ and Lodyne™).

After that, the isotiazolinone preservative (commercialized for, for example, Lonza™ and Rohm and Haas™ under the marks Isocil™, Liocide™, Kathon™ etc) added in the 0.2% concentration.

Finally, the microspheres in a 40% concentration and 0.2 to 3% methyl cellulose were added, with a small reduction in the rotation of the mixer.

The pH was controlled in order to maintain the emulsion between 6.5 to 9.5 to verify the emulsion stability.

The water and glycol that also is part of the emulsion formulation has a vehicle function, and help to avoid the incrustations and residues in the internal surface of the tubings. The oil also possesses the function of assisting the lubrication and preventing the drying of the formulation of the emulsion.

In addition, the emulsion has a stabilization package containing thickening and preservative agents, which maintain the stability of the emulsion, avoiding bacteria attack that cause irreversible damages to the flow additive function of the microspheres-loaded emulsion.

### Example 2

Same formulation described in the example 1, however with 30% in solids of microspheres.

### Example 3

Same formulation described in the example 1, however with 10% in solids of microspheres.

### Example 4

Same formulation described in the example 3, however with the addition of 5% polytetrafluorethylene resin (PTFE) in powder.

### Example 5

Same formulation described in the example 3, however with the addition of 0.5% polytetrafluorethylene resin (PTFE) in powder.

### Example 6

In order to demonstrate the efficiency of the flow additive according to the present invention it was prepared a test installation containing 6 m galvanized tubing equipped with a skirt to simulate the room temperature.

Said tubing contained a pump (similar to the one used in the extraction wells) for circulation of the oil. The installation also contained pressure and temperature sensors in the entrance and the exit of the tubing and a system of register and acquisition of data that monitor the installation for 24 hours, analyzing the differentials of pressure and temperature in the entrance and exit of the tubing. As the differential is lower, the efficiency is higher and the flow improvement.

The test was carried out in climatized room to keep constant temperature of 20 Celsius degrees, since the temperature could compromise the results. Therefore, the test was not subject to the influence of temperature in the test and flow.

Light (degree API 18) and heavy (degree API 13) oils were tested with initial shock treatment of 10,000 ppm of flow additive, followed by the treatment of maintenance of 1,000 ppm.

The process consisted of an additive shock treatment to clean and grease the duct. The shock treatment is defined by the calculation of the size of the oil duct. The additive feeding is then reduced to achieve the maintenance dose.

It was observed an improvement of 800% in the oil outflow in the shock treatment phase and 200% in the maintenance treatment phase.

It was also observed that as the period of use of the additive according to the present invention is bigger, the process becomes more efficient. Also, how much bigger the load of the flow, better the result.

The additive according to the present invention does not mixture with oil, but remains only in the surface of the walls of the tubing. In addition, as high the pumping volume, less product could be used.

After the stop in the feeding with the flow additive in the line of oil pumping, it was observed residual effect for a period of more four hours, after the stop of the system of oil pumping.

This proved a film formation in the internal surface of the tubing and that the concept of efficiency due the formation of a film that eliminates the attrition between the tubing walls and the oil functions.

Moreover, tests in laboratory with conventional reometers showed alteration in the rheology of oils containing the additive of the present invention.

In normal conditions, the pressure in the oil pumping line is about 6,500-7,000 kPa mbar in the entrance and 1,800-2,000 in the exit. With the use of the flow additive, the pressure is 650-750 in the entrance and 160-190 in the exit.

In field situation, it has a limit of pressure in the duct of 620 psi, allowing the pumping of about 80,000 liters per hour of light oil along with 20,000 liters per hour of heavy oil. When it reaches the control pressure, the oil outflow is modified to pump less and to hold the pressure.

The process according to the present invention allows pumping heavy oil with the same outflow of the light one, i.e., it increases in four times the outflow for a small line (about 120 kilometers).

The residual effect was proven after new tests with chemical products to modify the viscosity of the pumped crude oil. As the residual film was removed, an increase of the pressure and fall in the outflow of pumping of the line occurred.

The additive also revealed adequately stable in relation to shelf life, under more adverse the climatic conditions, as differences of temperatures caused for the exposition of the material climatic disturbances during the practical application of the product.

1. Flow additive for light or heavy crude oils characterized by comprising an aqueous emulsion containing hollow or solid synthetic microspheres, a superficial tension alteration component and high molecular weight polyelectrolytes, an antifreeze and flow enhancer selected from glycol and thickening agent.

2. Additive, according to claim 1, characterized by the fact that the aqueous emulsion comprises from 0.1% to 40% in solids of microspheres.

3. Additive, according to claim 1, characterized by the fact that the microspheres have external diameter equal or inferior than 1,000 microns.

4. Additive, according to claim 1, characterized by the fact that the microspheres are based on alkaline borosilicates or silicates, ceramic such as alumina or silica-alumina, polymers such as PVDC, metallic, zirconium oxides or mixtures thereof.

5. Additive, according to claim 1, characterized by the fact that the superficial tension alteration component is based on anionic, cationic and/or non ionic fluorated compounds.

6. Additive, according to claim 5, characterized by the fact that the fluorated compounds are selected from the group that consists of perfluoroctanes, perfluorobutanes, perfluoroalkyl such as sulfonates, carboxilates, alcoxilates, fluoroaliphatic esters, fluorochemistry acrylates, for instance ionic, cationic or non ionic.

7. Additive, according to claim 1, characterized by the fact that the 25 superficial tension alteration component is an anionic and/or non ionic tensoactive.

8. Additive, according to claim 5, characterized by the fact that the tensoactives are selected from sodium dioctyl sulfosuccinate, ethoxylate secondary alcohol, ethoxylate nonil phenol with 4 and 5 ethoxylation moles.

9. Additive, according to claim 1, characterized by the fact that the aqueous emulsion additionally comprises a stabilization and preservationsystem based on synthetic thickeners and/or preservatives.

10. Additive, according to claim 1, characterized by the fact that aqueous emulsion comprises 0.5 to 10% of a resin based on polytetrafluorethylene.

11. Additive, according to claim 1, characterized by the fact that the polyelectrolytes have anionic charge.

12. Additive, according to claim 1, characterized by the fact that the aqueous emulsion comprises from 20 to 60% glycol as antifreeze and flow enhancer agent.

13. Additive, according to claim 1, characterized by the fact that comprise from 0.2 to 3% a thickening agent selected from at least one cellulose derivative.

14. Additive, according to claim 13, characterized by the fact that the thickening agent is methyl cellulose.

15. Use of a flow additive according to claim 1 characterized by the fact that is in order to improve the extraction, pumping and/or transport of light or heavy crude oils.

16. Use, according to claim 15, characterized for the fact that is in order to improve the extraction, pumping and/or transport of light or heavy crude oils in regions with temperature below of 0 Celsius degrees.

17. Process to improve the extraction, pumping and/or transport of light or heavy crude oils characterized by the fact that comprises to add a flow additive according to claim 1 in the oil flow in a concentration from 100 to 10,000 ppm.
